(19) United States
(12) Patent Application Publication
(10) Pub. No.: US 2012/0042105 A1
(43) Pub. Date: Feb. 16, 2012

(54) BUS ARBITRATION APPARATUS

(75) Inventors: Takashi MAEDA, Kanagawa (JP); Mamoru SUMIDA, Kanagawa (JP); Koukichi HASHIMOTO, Tokyo (JP); Masatoshi MATSUSHITA, Kanagawa (JP)

(73) Assignee: Panasonic Corporation, Osaka (JP)

(21) Appl. No.: 13/279,974

(22) Filed: Oct. 24, 2011

Related U.S. Application Data
(63) Continuation of application No. PCT/JP2010/003536, filed on May 26, 2010.

(30) Foreign Application Priority Data
Jan. 19, 2010 (JP) 2010-008928

(51) Int. Cl. G06F 13/00

(52) U.S. Cl. 710/110

(57) ABSTRACT

An arbitration circuit 108 receives a read/write request from a master 101, such as a CPU, in which low latency is required, at a regular interval, such that the master 101 performs memory access with low latency. A remaining band which is not used by the master 101 is allocated to masters 102 and 103, such as a DMA controller, in which a wideband is required, thereby ensuring a necessary band. When a read/write request is retained in a buffer 119 of a slave 118, the arbitration circuit 108 suppresses the acceptance of the read/write requests from the masters 102 and 103 having low priority. Therefore, it is possible to provide a bus arbitration apparatus capable of transmitting a request from a specific master to a slave with low latency, and to ensure a band necessary for another master.

### BACKGROUND OF THE INVENTION

1. Field of the Invention

The present invention relates to a bus arbitration apparatus which arbitrates a bus for use in transmission from a master to a slaver.

2. Description of the Related Art

FIG. 10 is a block diagram showing a bus arbitration apparatus in the related art. The bus arbitration apparatus shown in FIG. 10 includes a bus 207, a CPU 201, a DMA controller 202, and a slave 209. The DMA controller 202 has a DMA request detection unit 203, a DMA control unit 204, a bus availability frequency register 205, and a bus availability counter 206. The bus 207 has an arbitration circuit 208. The slave 209 has a buffer 210 (see Patent Document 1).

In the bus arbitration apparatus, the DMA controller 202 monitors the bus 207, and counts a bus access frequency of another master, such as the CPU 201, or the DMA controller 202 by the bus availability counter 206. The DMA control unit 204 controls a DMA issuance frequency such that the value of the bus availability counter 206 becomes the ratio of the bus access frequency between the DMA controller 202 and the CPU 201 set in advance in the bus availability frequency register 205. Thus, it is possible to predict a band which can be used by another master, such as the CPU 201, during DMA (Direct Memory Access) transfer.

In recent years, with an increase in data processing, the amount of DMA transfer increases, and in order to ensure real-time performance, there is a demand that the CPU performs memory access with low latency (delay time). When a bus supports outstanding transfer which can issue the next read/write request before previous read processing or write processing is completed, or the like, there is an increasing possibility that the bus becomes congested (see Non-Patent Document 1).

Patent Document 1: JP-A-2002-24156

Non-Patent Document 1: AMBA AXI Protocol v1.0 specification (https://www.jp.arm.com/document/manual/files/IHI0022 BJ-00.pdf)

### SUMMARY OF THE INVENTION

The bus arbitration apparatus in the related art has the following problem. That is, the DMA transfer frequency is suppressed depending on the congestion condition of the bus 207, thereby ensuring the band of the CPU 201. However, when a number of read/write requests are stored in the buffer 210 of the slave 209 by outstanding transfer, there is a possibility that the latency of the CPU 201 significantly increases. For this reason, it is difficult to ensure real-time performance of the CPU 201.

An object of the invention is to provide a bus arbitration apparatus capable of transmitting a request from a specific master to a slave with low latency and ensuring a band necessary for another master.

An aspect of the invention provides a bus arbitration apparatus which arbitrates a bus. The bus arbitration apparatus includes a plurality of masters, at least one slave, a bus to which the plurality of masters and the slave are connected and which is used for transmission from the plurality of masters to the slave, an arbitration unit configured to receive a request from a specific master from among the plurality of masters with higher priority than a request from another master, and a monitoring unit configured to monitor the requests from the plurality of masters transmitted to the slave through the bus. As a result of monitoring by the monitoring unit, when the requests from the plurality of masters transmitted to the slave are retained, the arbitration unit performs control such that the request from another master decreases.

As described above, if the request from the specific master is received with higher priority, it is possible to transmit the request from the specific master to the slave with low latency and to ensure a band necessary for another master. When a request from a master is retained, a request from another master with low priority is suppressed, such that, even when the slave is congested, it is possible to suppress an increase in latency when transmitting the request from the specific master to the slave.

In the bus arbitration apparatus, the monitoring unit may count the number of requests transmitted from another master to the slave, and when the counted number exceeds a predetermined value, may output a restriction signal to the arbitration unit. When the restriction signal is output, the arbitration unit may not receive a request from another master.

For this reason, it is possible to suppress the number of requests from another master so as not to exceed a given number, and to ensure low-latency performance for the specific master.

The bus arbitration apparatus may further include a memory which is connected to the slave and to which access is made in accordance with the requests from the masters. The monitoring unit may monitor the state of the memory, and when the memory is in a predetermined state, may output the restriction signal to the arbitration unit. When the restriction signal is output, the arbitration unit may not receive the request from another master.

For this reason, it is possible to realize low latency when a master, such as a CPU, performs memory access, and to ensure real-time performance.

In the bus arbitration apparatus, the slave may include a holding unit which holds the requests from the plurality of masters, and the monitoring unit. The bus may include the arbitration unit.

As described above, the arbitration unit is provided in the bus, making it possible to cope with a number of slaves.

In the bus arbitration apparatus, the slave may include a holding unit which holds the requests from the plurality of masters, the monitoring unit, and the arbitration unit.

As described above, the arbitration unit is provided in the slave, making it possible to simplify the structure of the bus.

In the bus arbitration apparatus, the plurality of masters may be divided into two or more groups including a first group to which the specific master belongs and a second group to which another master belongs. The arbitration unit may select the first group and the second group at a regular interval, when the first group is selected, may select the specific master at a regular interval, and when the second group is selected, may select another master at a regular interval.

As described above, even when there are an enormous number of requests from another master, if the request of the specific master is received at a regular interval, it is possible to transmit the request of the specific master to the slave with low latency and to realize arbitration such that the request from another master can be transmitted to the slave by a given amount.

In the bus arbitration apparatus, the specific master may be a master in which low latency is required, and another master may be a master in which a wideband is required.

According to the bus arbitration apparatus of the invention, it is possible to transmit the request from the specific master to the slave with low latency, and to ensure a band necessary for another master. Even when the slave is congested, it is possible to suppress an increase in latency when transmitting the request from the specific master to the slave.

### BRIEF DESCRIPTION OF THE DRAWINGS

FIG. 1 shows a block diagram showing a bus arbitration apparatus of a first embodiment.

FIG. 2 shows a timing chart showing the operation of a bus.

FIG. 3 shows a flowchart showing the operation of an outstanding number confirmation unit.

FIG. 4 shows a diagram showing processing in an arbitration circuit.

FIG. 5 shows a flowchart showing the operation of the arbitration circuit.

FIG. 6 shows a block diagram showing a bus arbitration apparatus of a second embodiment.

FIG. 7 shows a flowchart showing the operation of a SDRAM access monitoring unit.

FIG. 8 shows a block diagram showing a bus arbitration apparatus of a third embodiment.

FIG. 9 shows a flowchart showing the operation of an arbitration circuit.

FIG. 10 shows a block diagram showing a bus arbitration apparatus in the related art.

FIG. 11 shows a block diagram showing a bus arbitration apparatus 108 of a fourth embodiment.

FIG. 12 shows a diagram showing an example of the circuit configuration of the arbitration circuit.

FIG. 13 shows a diagram showing the arbitration results of the arbitration circuit in cycles when the masters constantly transmit the read/write requests and to the slave.

FIG. 14 shows a diagram showing the arbitration results of the arbitration circuit in cycles when the masters constantly transmit the read/write requests to the slave.

FIG. 15 shows a diagram showing the arbitration results in cycles when the arbitration results of FIGS. 13 and 14 are arbitrated with the round-robin arbitration

FIG. 16 shows a diagram showing the arbitration results of the arbitration circuit in cycles during the operation of the arbitration circuit when the masters constantly transmit the read/write requests to the slave.

### DETAILED DESCRIPTION OF THE PREFERRED EMBODIMENTS

Hereinafter, embodiments of the invention will be described with reference to the drawings.

### First Embodiment

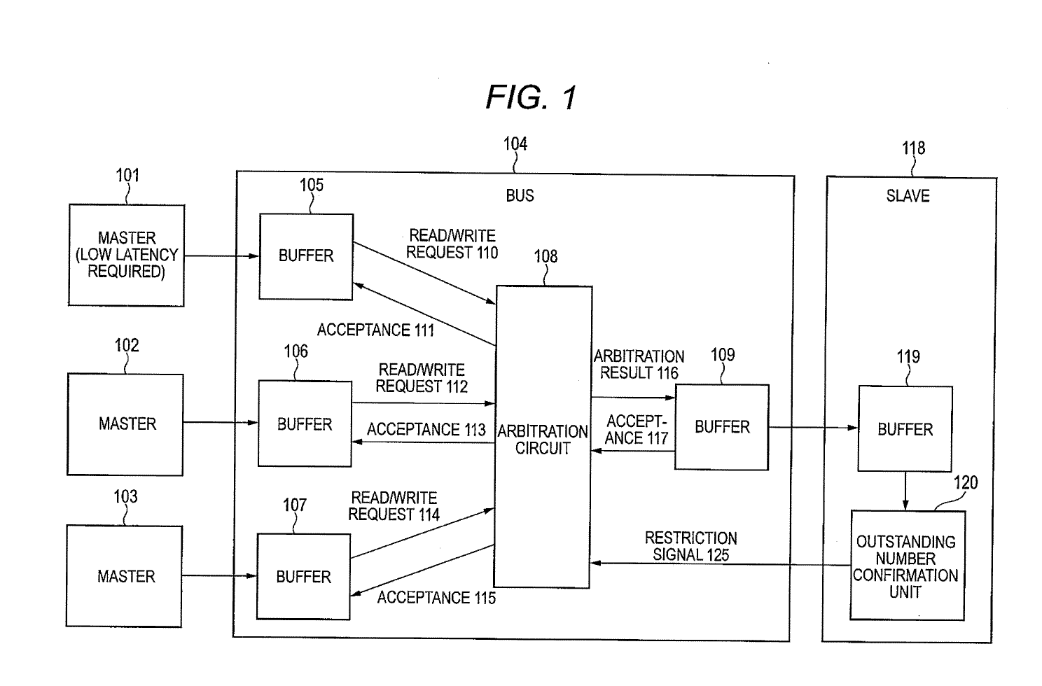

FIG. 1 is a block diagram showing a bus arbitration apparatus of a first embodiment. As shown in FIG. 1, the bus arbitration apparatus of the first embodiment includes a bus 104, masters 101, 102, and 103, and a slave 118. The master 101 is a master in which low latency is required at the time of access to the slave 118. The master 101 is, for example, a CPU. The masters 102 and 103 are masters in which a wideband is required. The masters 102 and 103 are, for example, wideband DMA controllers.

As described above, a plurality of masters is divided into a first group to which the master 101 requiring low latency belongs and a second group to which the masters 102 and 103 requiring a wideband belong. The number of groups and the number of masters in each group are arbitrary numbers.

The bus 104 has buffers 105, 106, and 107, an arbitration circuit 108, and a buffer 109. The slave 118 has a buffer 119 and an outstanding number confirmation unit 120.

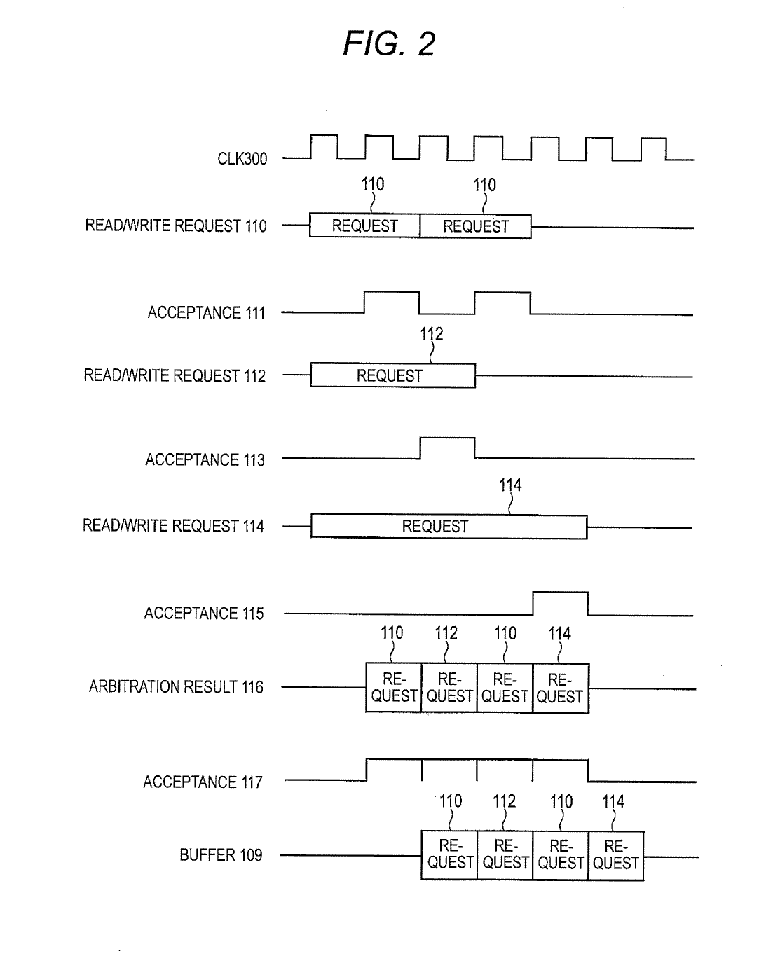

The operation of the bus arbitration apparatus of the first embodiment will be described. FIG. 2 is a timing chart showing the operation of the bus 104. The bus 104 operates in synchronization with a clock (CLK) 300. In the bus 104, if read/write requests 110, 112, and 114 of the masters 101, 102, and 103 are respectively received by the buffers 105, 106, and 107, the arbitration circuit 108 stores the read/write requests stored in the buffers 105 to 107 in the buffer 109 with priority based on arbitration systems described below. The bus 104 sends the read/write requests stored in the buffer 109 to the buffer 119 of the slave 118.

The outstanding number confirmation unit 120 in the slave 118 counts the number of read/write requests 112 and 114 from the masters 102 and 103 stored in the buffer 119. If the counted number of read/write requests 112 and 114 exceeds a predetermined value (a threshold value set by register access of a master, or the like), the outstanding number confirmation unit 120 outputs a restriction signal 125 to the arbitration circuit 108 so as not to accept the read/write requests 112 and 114 from the masters 102 and 103. When the restriction signal 125 is output, the arbitration circuit 108 suppresses the read/write requests 112 and 114 from the masters 102 and 103 so as not to be accepted, and places priority on the read/write request 110 of the master 101.

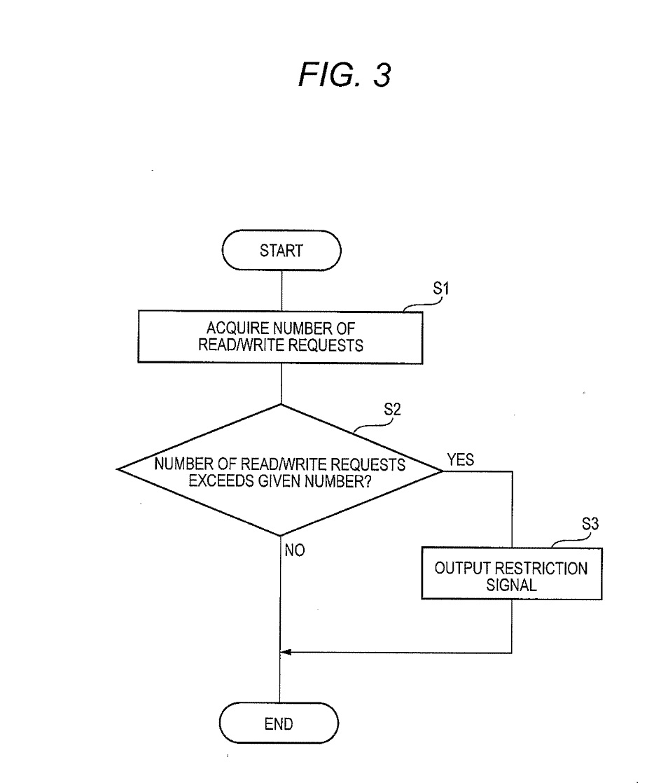

FIG. 3 is a flowchart showing the operation of the outstanding number confirmation unit 120. The operation is performed periodically. The outstanding number confirmation unit 120 references the buffer 119 and acquires the number of read/write requests 112 and 114 from the masters 102 and 103 stored in the buffer 119 (Step S1). The outstanding number confirmation unit 120 determines whether or not the number of read/write requests 112 and 114 from the masters 102 and 103 stored in the buffer 119 exceeds a predetermined value (Step S2). When the number of read/write requests 112 and 114 does not exceed the predetermined value, the outstanding number confirmation unit 120 ends the processing. When the number of read/write requests 112 and 114 exceeds the predetermined value, the outstanding number confirmation unit 120 outputs the restriction signal 125 to the arbitration circuit 108 to place priority on the read/write request 110 of the master 101 (Step S3).

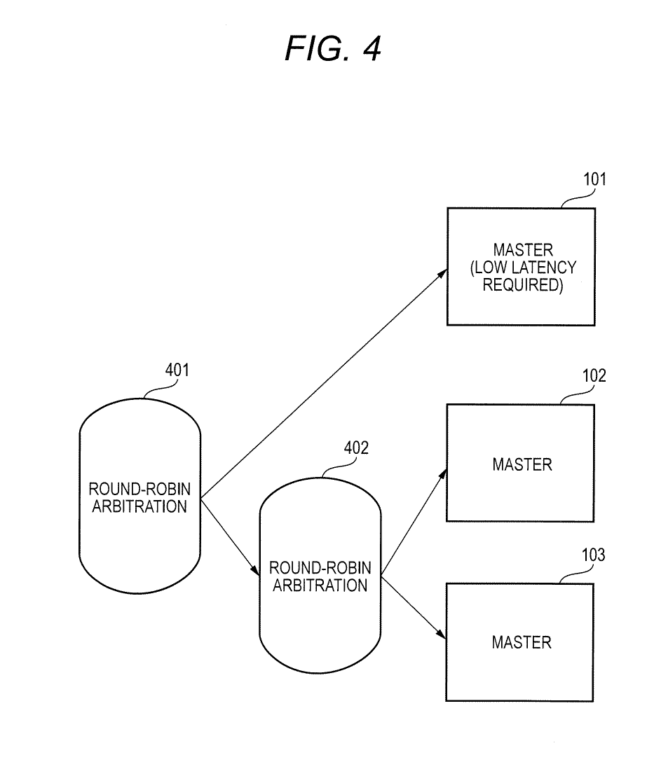

FIG. 4 is a diagram showing processing in the arbitration circuit 108. In the case of arbitration by the arbitration circuit 108, when the ratio of the necessary bands in the first group and the second group is one-to-one, the first group is selected once for every two cycles by round-robin arbitration 401 (first round-robin arbitration system), and priority is placed on the master 101 in the first group. The masters 102 and 103 in the second group are selected evenly in the remaining cycles by round-robin arbitration 402 (second round-robin arbitration system), and priority is placed on each master.

With the arbitration systems, the arbitration circuit 108 controls the bus 104, which is used for transmission from a master to a slave, such that high priority is placed on the master 101 requiring low latency once for every two cycles, and also controls the bus 104 such that priority is placed on the masters 102 and 103 evenly in other cycles.

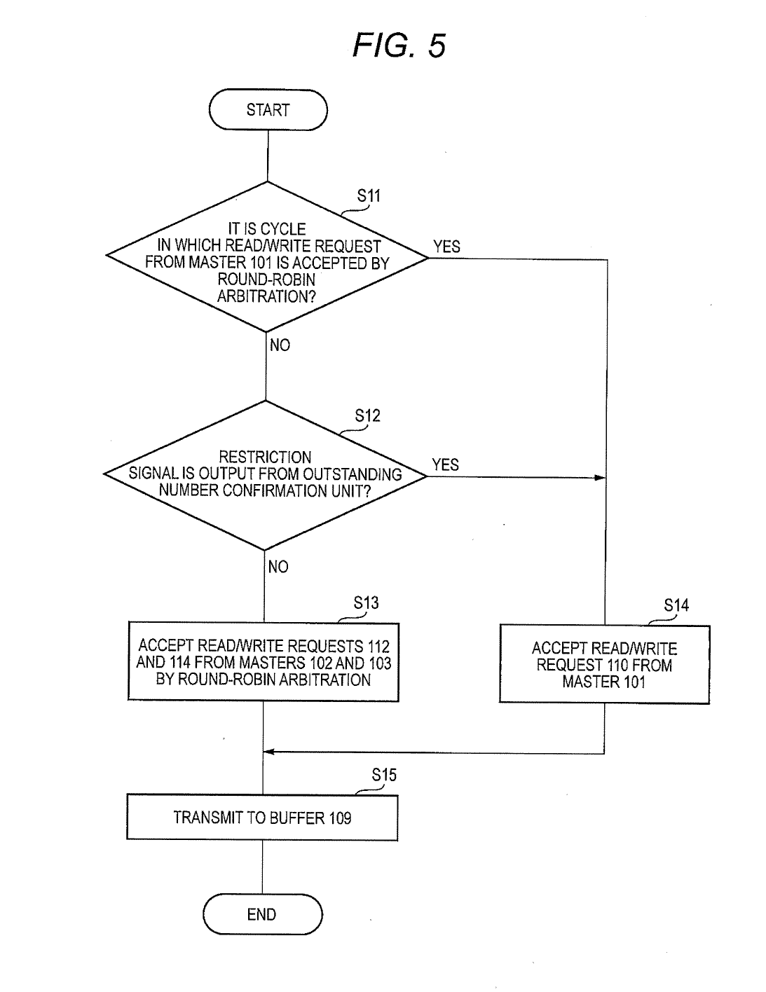

FIG. 5 is a flowchart showing the operation of the arbitration circuit 108. The operation is performed in each cycle in synchronization with the clock (CLK) 300. The arbitration circuit 108 determines whether or not it is a cycle in which the read/write request 110 from the master 101 is accepted on the basis of the round-robin arbitration 401 shown in FIG. 4 (Step S11). When it is a cycle in which the read/write request 110 from the master 101 is accepted, the arbitration circuit 108 accepts the read/write request 110 from the master 101 stored in the buffer 105 (Step S14), and stores the accepted read/write request in the buffer 109 as an arbitration result 116 (Step S15). In Step S14, the arbitration circuit 108 returns a signal (acceptance 111 in FIG. 1) indicating the acceptance of the read/write request to the master 101. In Step S15, the buffer 109 returns a signal (acceptance 117 in FIG. 1) indicating the acceptance of the arbitration result 116 to the arbitration circuit 108.

FIG. 16 is a diagram showing the arbitration results of the arbitration circuit 108 in cycles 1 to 12 during the operation of the arbitration circuit 108 when the masters 101, 102, and 103 constantly transmit the read/write requests 110, 112, and 114 to the slave 118. In the round-robin arbitration 401, priority is placed on the master 101 in the first group once for every two cycles, such that the master 101 can access the slave 118 once for every two cycles. The round-robin arbitration 401 enables arbitration by the round-robin arbitration 402 in the remaining cycles. In the round-robin arbitration 402, priority is placed on the masters 102 and 103 alternately, such that the masters 102 and 103 can access the slave 118 once for every four cycles.

When it is not a cycle in which the read/write request 110 from the master 101 is accepted, the arbitration circuit 108 determines whether or not the restriction signal 125 is output from the outstanding number confirmation unit 120 such that the read/write requests 112 and 113 from the masters 102 and 103 are not accepted (Step S12). When the restriction signal 125 is output, the arbitration circuit 108 progresses the processing to Step S14, and accepts the read/write request 110 from the master 101. At this time, while the read/write request 110 from the master 101 is not accepted in Step S14, the operation may end.

When the restriction signal 125 is not output, the arbitration circuit 108 accepts the read/write request 112 from the master 102 stored in the buffer 106 or the read/write request 114 from the master 103 stored in the buffer 107 in accordance with the priority based on the round-robin arbitration 402 (Step S13). In Step S13, the arbitration circuit 108 returns a signal (acceptance 113 or 115 in FIG. 1) indicating the acceptance of the read/write request to the master 102 or the master 103. Next, the arbitration circuit 108 stores the accepted read/write request in the buffer 109 as the arbitration result 116 (Step S15). In Step S15, the buffer 109 returns a signal (acceptance 117 in FIG. 1) indicating the acceptance of the arbitration result 116 to the arbitration circuit 108.

The bus 104 stores the accepted read/write request in the buffer 109 as the arbitration result 116 of the arbitration circuit 108, and sends the read/write request stored in the buffer 109 to the buffer 119 of the slave 118 in the next cycle.

As described above, according to the bus arbitration apparatus of the first embodiment, the arbitration circuit 108 accepts the read/write request from the master 101, such as a CPU, requiring low latency at a regular interval (high priority), such that access from the master 101 can be made with low latency. The remaining band which is not used by the master 101 is allocated to the masters 102 and 103, such as a DMA controller, requiring a wideband, such that a necessary band can be ensured for the masters 102 and 103.

When a read/write request is retained in the buffer 119 of the slave 118, the arbitration circuit 108 changes the arbitration system to suppress the acceptance of the read/write requests from the masters 102 and 103 having low priority. Thus, even when the bus 104 or the buffer in the slave 118 is congested, it is possible to suppress an increase in latency when the master 101 accesses the slave 118. As described above, it is possible to suppress the number of requests from the masters 102 and 103 so as not to exceed a given number, and to ensure low-latency performance of the master 101. The arbitration circuit is provided in the bus, making it possible to cope with a number of slaves.

### Second Embodiment

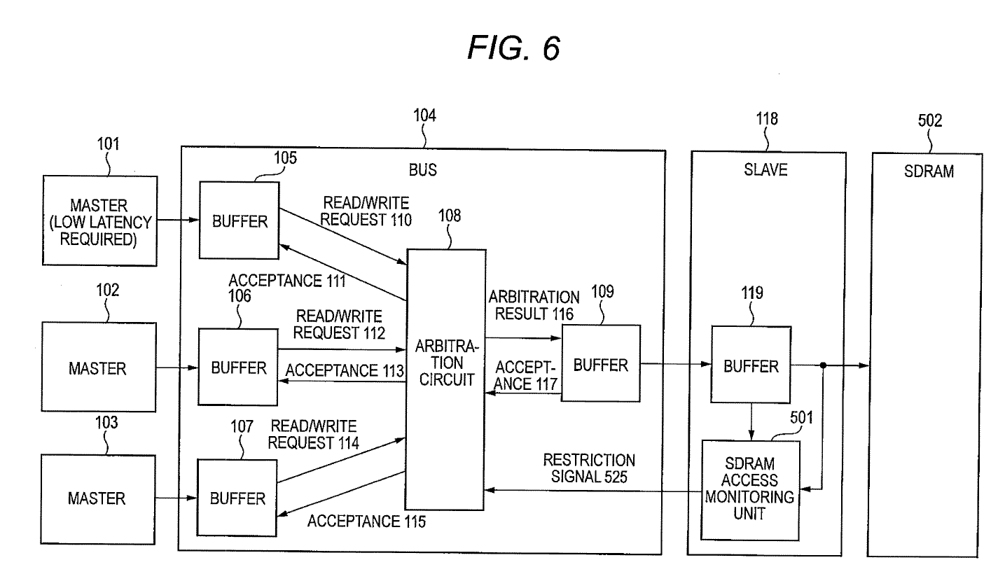

FIG. 6 is a block diagram showing a bus arbitration apparatus of a second embodiment. The same constituent elements as those in the first embodiment are represented by the same reference numerals. As shown in FIG. 6, the bus arbitration apparatus of the second embodiment includes a master 101 in which low latency is required when memory access is performed, masters 102 and 103 in which a wideband is required, a slave 118, a bus 104, and a SDRAM 502.

The bus 104 has buffers 105 to 107, an arbitration circuit 108, and a buffer 109. The slave 118 has a buffer 119 and a SDRAM access monitoring unit 501.

The bus 104 receives the read/write requests of the masters 101 to 103 by the buffers 105 to 107, and stores the read/write requests stored in the buffers 105 to 107 in the buffer 109 on the basis of the priority of the arbitration circuit 108. The bus 104 sends the read/write requests stored in the buffer 109 to the buffer 119 of the slave 118. The slave 118 performs memory access to the SDRAM 502 serving as a memory in accordance with the read/write requests stored in the buffer 119.

The SDRAM access monitoring unit 501 monitors access of the slave 118 to the SDRAM 502. As a result of monitoring, if it is detected that the SDRAM 502 is in a predetermined state, the SDRAM access monitoring unit 501 outputs a restriction signal 525 to the arbitration circuit 108 so as not to accept the read/write requests 112 and 114 from the masters 102 and 103. The situation that the SDRAM 502 is in a predetermined state refers to, for example, the occurrence of overhead due to access to a different ROW address, or the like.

If the restriction signal 525 is received, the arbitration circuit 108 performs control such that the read/write requests 112 and 114 from the masters 102 and 103 are not accepted, and places priority on the read/write request 110 of the master 101.

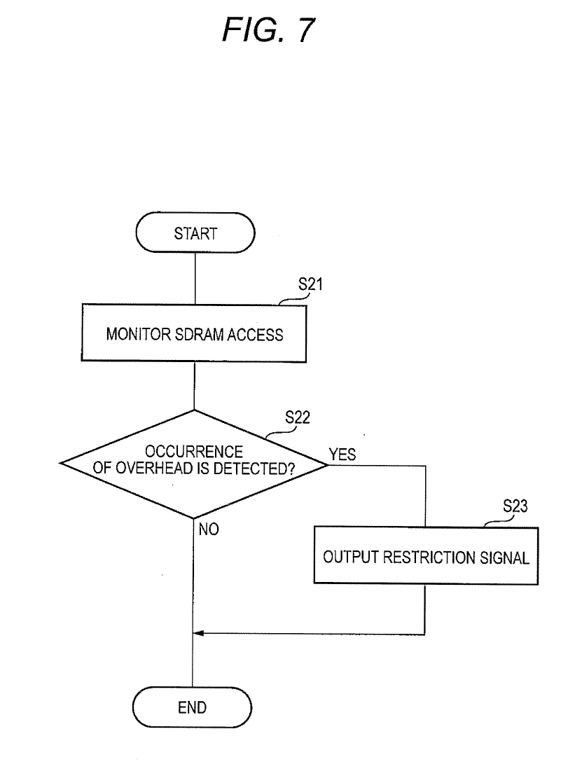

FIG. 7 is a flowchart showing the operation of the SDRAM access monitoring unit 501. The operation is performed periodically. The SDRAM access monitoring unit 501 monitors access of the slave 118 to the SDRAM 502 (Step S21). The SDRAM access monitoring unit 501 determines whether or not the occurrence of overhead due to access to a different ROW address, or the like, is detected (Step S22). When the occurrence of overhead is not detected, the SDRAM access monitoring unit 501 ends the processing. When the occurrence of overhead is detected, the SDRAM access monitoring unit 501 outputs the restriction signal 525 to the arbitration circuit 108 such that the read/write requests from the masters 102 and 103 are not accepted (Step S23).

The operation of the arbitration circuit 108 is the same as in the first embodiment, except that, in Step S12 of FIG. 5, the restriction signal 525 from the outstanding number confirmation unit 120 is substituted with the restriction signal of the SDRAM access monitoring unit 501.

As described above, according to the bus arbitration apparatus of the second embodiment, it is possible to realize low latency when the master 101, such as a CPU, performs memory access, and to ensure real-time performance.

### Third Embodiment

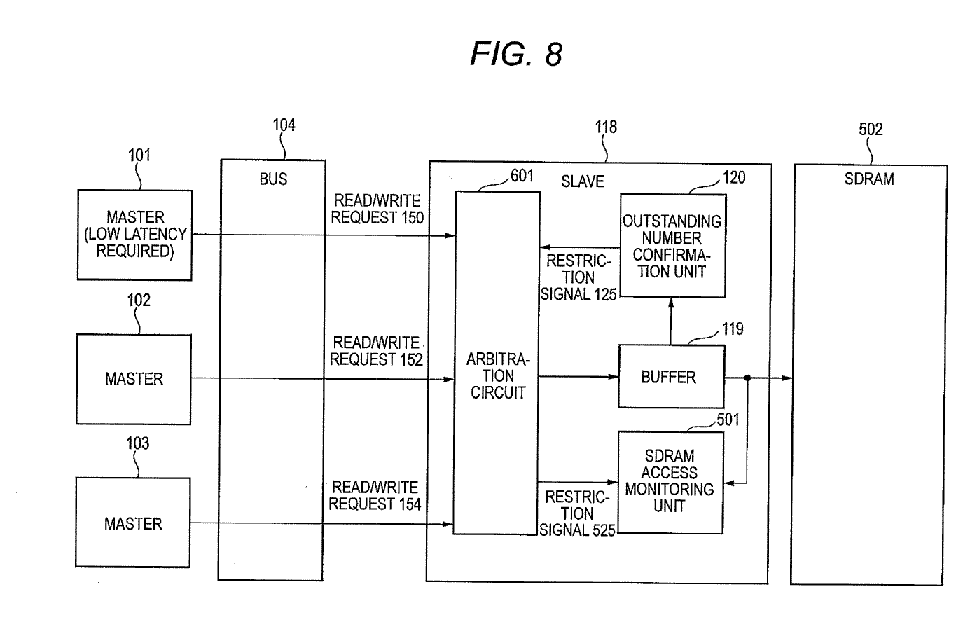

FIG. 8 is a diagram showing a bus arbitration apparatus of third embodiment. The same constituent elements as those in the first or second embodiment are represented by the same reference numerals. In the third embodiment, unlike the first or second embodiment, an arbitration circuit 601 is provided in a slave 118.

As shown in FIG. 8, the bus arbitration apparatus of the third embodiment includes a master 101 in which low latency is required when memory access is performed, masters 102 and 103 in which a wideband is required, a slave 118, a bus 104, and a SDRAM 502.

The slave 118 has an arbitration circuit 601, a buffer 119, an outstanding number confirmation unit 120, and a SDRAM access monitoring unit 501. The slave 118 stores read/write requests 150, 152, 154 of the masters 101 to 103 in the buffer 119 on the basis of the priority of the arbitration circuit 601. The slave 118 performs memory access to the SDRAM 502 serving as a memory in accordance with the read/write requests stored in the buffer 119.

The outstanding number confirmation unit 120 counts the number of read/write requests 152 and 154 from the masters 102 and 103 stored in the buffer 119. If the counted number of read/write requests 112 and 114 exceeds a predetermined value, the outstanding number confirmation unit 120 outputs a restriction signal 125 to the arbitration circuit 601 such that the read/write requests 152 and 154 from the masters 102 and 103 are not accepted. If the restriction signal 125 is received, the arbitration circuit 601 performs control such that the read/write requests 152 and 154 from the masters 102 and 103 are not accepted, and places priority on the read/write request 150 from the master 101. The operation of the outstanding number confirmation unit 120 is the same as the operation shown in the flowchart of FIG. 3 of the first embodiment.

The SDRAM access monitoring unit 501 monitors access of the slave 118 to the SDRAM 502. As a result of monitoring, if it is detected that the SDRAM 502 is in a predetermined state, the SDRAM access monitoring unit 501 outputs the restriction signal 525 to the arbitration circuit 601 such that the read/write requests 152 and 154 from the masters 102 and 103 are not accepted. The situation that the SDRAM 502 is in a predetermined state refers to, for example, the occurrence of overhead due to access to a different ROW address, or the like.

If the restriction signal 525 is received, the arbitration circuit 601 performs control such that the read/write requests 152 and 154 from the masters 102 and 103 are not accepted, and places priority on the read/write request 110 from the master 101. The operation of the SDRAM access monitoring unit 501 is the same as the operation shown in the flowchart of FIG. 7 of the second embodiment.

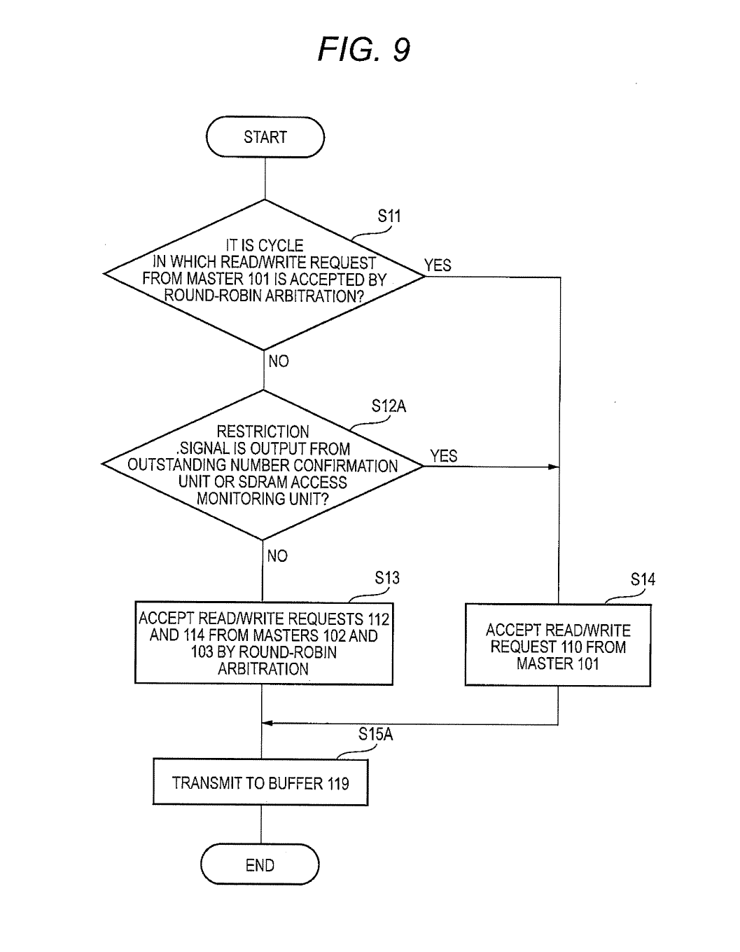

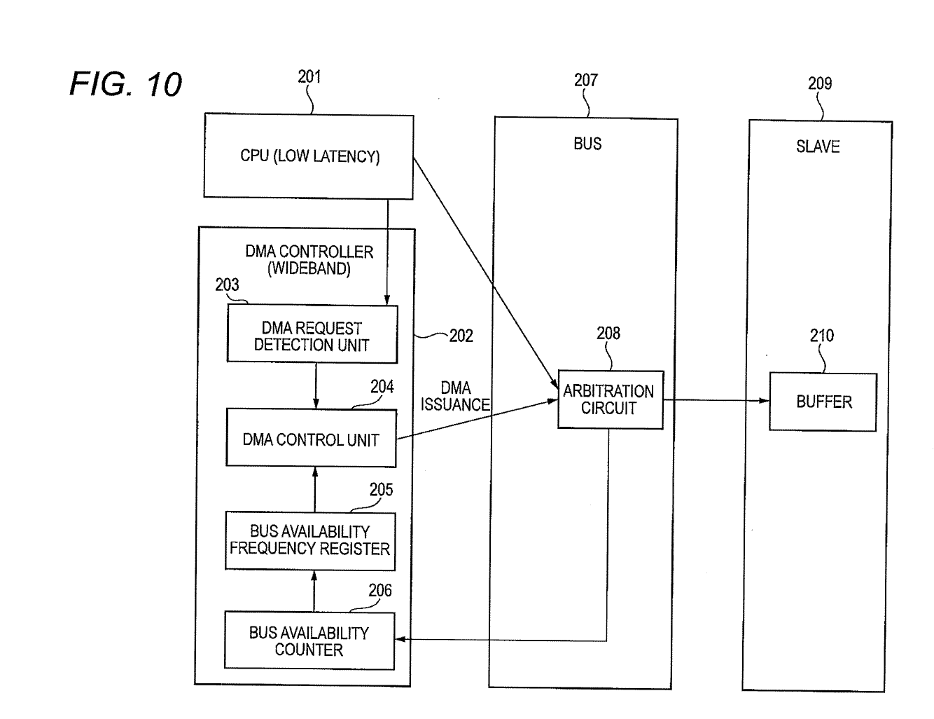

FIG. 9 is a flowchart showing the operation of the arbitration circuit 601. The operation is performed in each cycle in synchronization with the clock (CLK) 300. The operation of the arbitration circuit 601 is substantially the same as the operation shown in the flowchart of FIG. 5 of the first embodiment, and only a different operation will be described.

In Step S11, when it is not a cycle in which the read/write request 110 from the master 101 is accepted, the arbitration circuit 601 determines whether or not the restriction signal 125 or 525 is output from the outstanding number confirmation unit 120 or the SDRAM access monitoring unit 501 such that the read/write requests 152 and 154 from the masters 102 and 103 are not accepted (Step S12A).

The arbitration circuit 108 stores the read/write request accepted in Step S13 or Step S14 in the buffer 119 (Step S15A). Other operations are the same as the flowchart of FIG. 5.

As described above, according to the bus arbitration apparatus of the third embodiment, the arbitration circuit 601 is provided in the slave 118, thereby simplifying the structure of the bus 104. Both the outstanding number confirmation unit 120 and the SDRAM access monitoring unit 501 are provided in the slave 118, thereby suppressing the retention of the read/write request in the buffer 119. Therefore, low-latency performance can be further ensured for the master 101.

The invention is not limited to the configuration of the foregoing embodiments, and the invention may be applied to any configuration insofar as the functions described in the appended claims or the functions in the configuration of the embodiments can be achieved.

For example, although in the foregoing embodiments, a case has been described in which a single slave is provided, the invention may be similarly applied to a case where two or more slaves are connected to a bus. As described above, the number of masters is arbitrary, and when a plurality of masters are divided into groups, the number of groups and the number of masters in each group are not particularly limited.

Although in the foregoing embodiments, a SDRAM is used as a memory which is connected to a slave, the invention is not limited thereto. A storage medium, such as a ROM or a hard disk, may be used.

### Fourth Embodiment

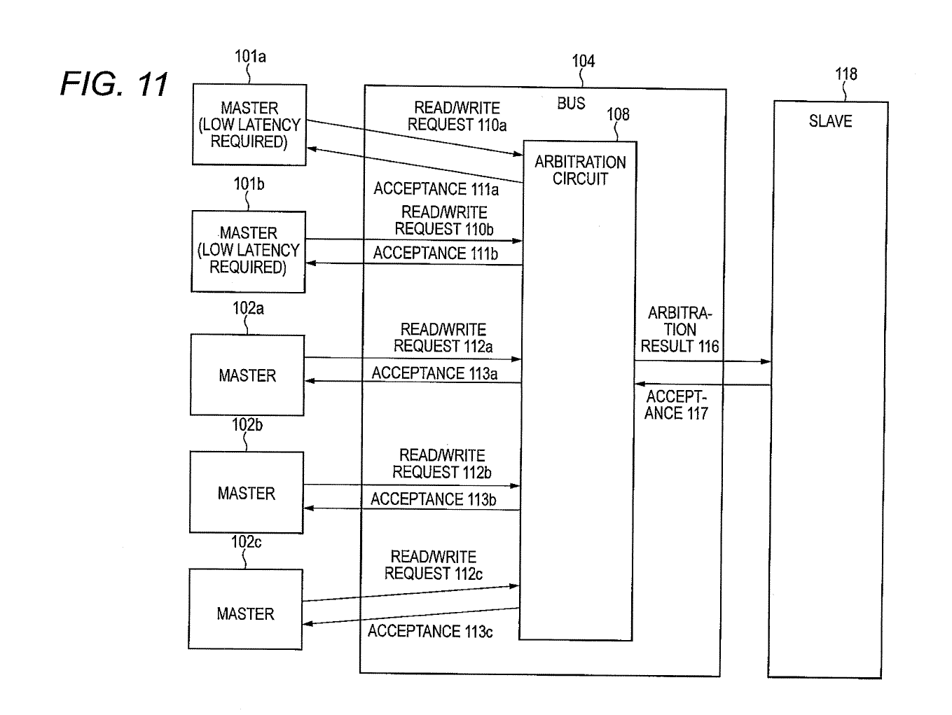

FIG. 11 is a block diagram showing a bus arbitration apparatus of a fourth embodiment. The same constituent elements as those in the first to third embodiments are represented by the same reference numerals. As shown in FIG. 11, the bus arbitration apparatus of the fourth embodiment includes masters 101a and 101b (CPU or the like) in which low latency is required when memory access is performed, masters 102a, 102b, and 102c (DMA or the like) in which low latency is not required and a memory access frequency is high, a slave 118, a bus 104, and an arbitration circuit 108.

The operation of the arbitration circuit 108 of the fourth embodiment will be described. In the bus 104, the arbitration circuit 108 sends read/write requests 110a, 110b, 112a, 112b, 112c of the masters 101a, 101b, 102a, 102b, and 102c to the slave 118 in accordance with priority based on arbitration systems described below. The operation is performed in each cycle in synchronization with the clock (CLK) 300.

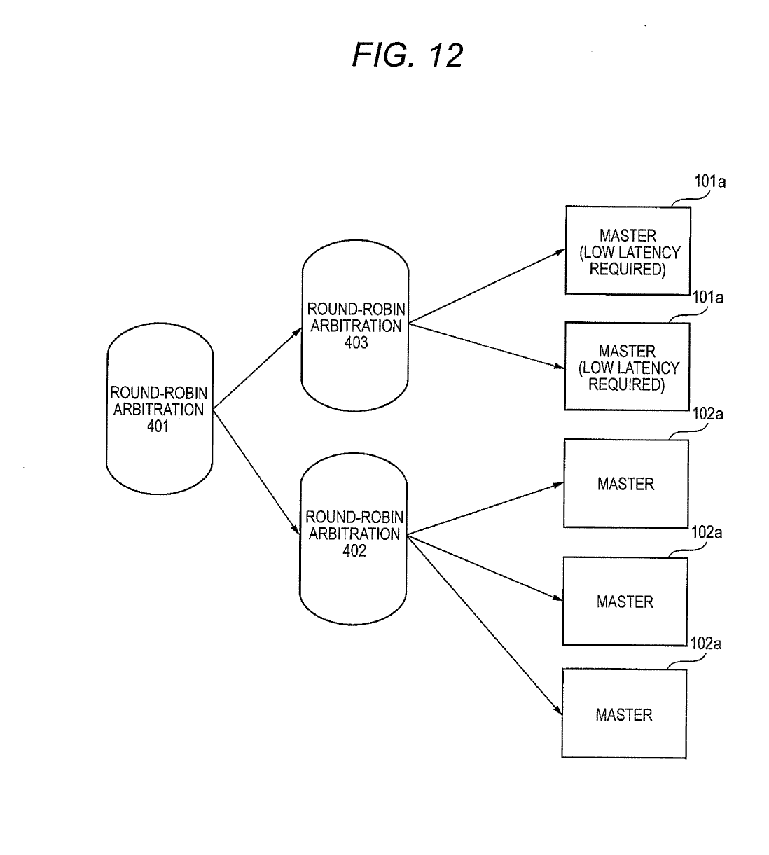

FIG. 12 is a diagram showing an example of the circuit configuration of the arbitration circuit 108. With regard to arbitration of the arbitration circuit 108, round-robin arbitration 403 (third round-robin arbitration system) of the first group is given arbitration rights once for every two cycles by the round-robin arbitration 401 (first round-robin arbitration system), and the round-robin arbitration 403 arbitrates the masters 101a and 101b in the first group. The round-robin arbitration 401 gives arbitration rights to round-robin arbitration 402 (second round-robin arbitration system) of the second group in the remaining cycles in which the round-robin arbitration 403 is not given arbitration rights, and the round-robin arbitration 402 arbitrates the masters 102a, 102b, and 102c in the second group.

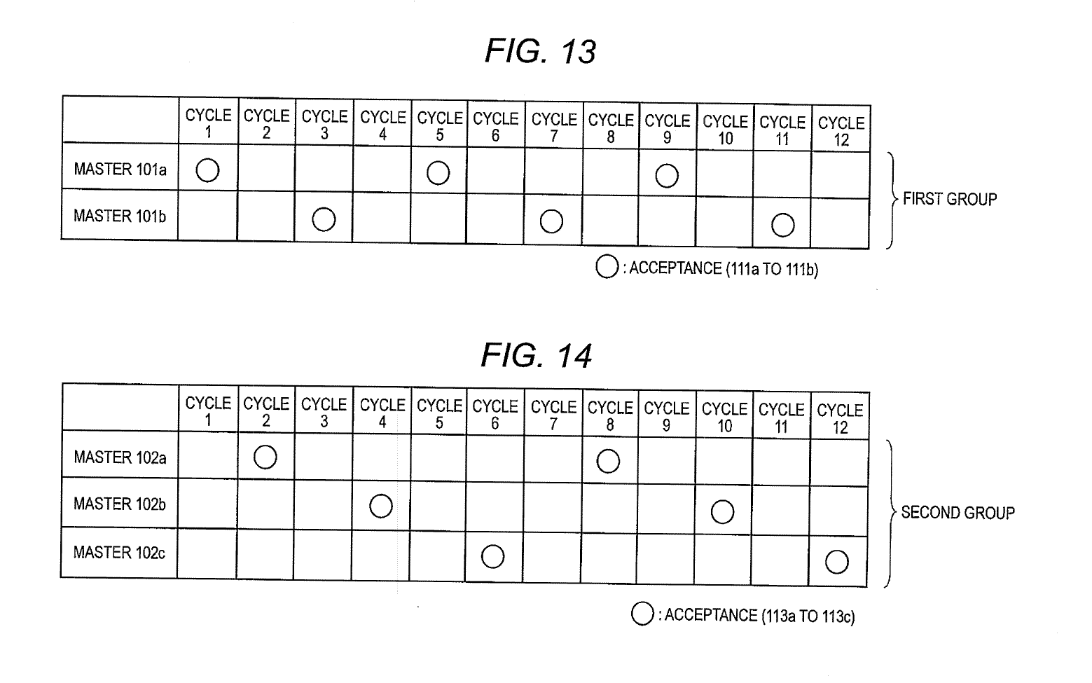

The specific operation of FIG. 12 will be described with reference to FIGS. 13 to 15. FIG. 13 is a diagram showing the arbitration results of the arbitration circuit 108 in cycles 1 to 12 when the masters 101a and 101b constantly transmit the read/write requests 110a and 110b to the slave 118. In a cycle in which the round-robin arbitration 401 is given arbitration rights once for every two cycles, the round-robin arbitration 403 of the first group places priority on the masters 101a and 101b alternately.

FIG. 14 is a diagram showing the arbitration results of the arbitration circuit 108 in cycles 1 to 12 when the masters 102a, 102b, and 102c constantly transmit the read/write requests 112a, 112b, and 112c to the slave 118. In a cycle in which priority is placed on the round-robin arbitration 401 once for every two cycles, the round-robin arbitration 402 of the second group places priority on the masters 102a, 102b, and 102c alternately.

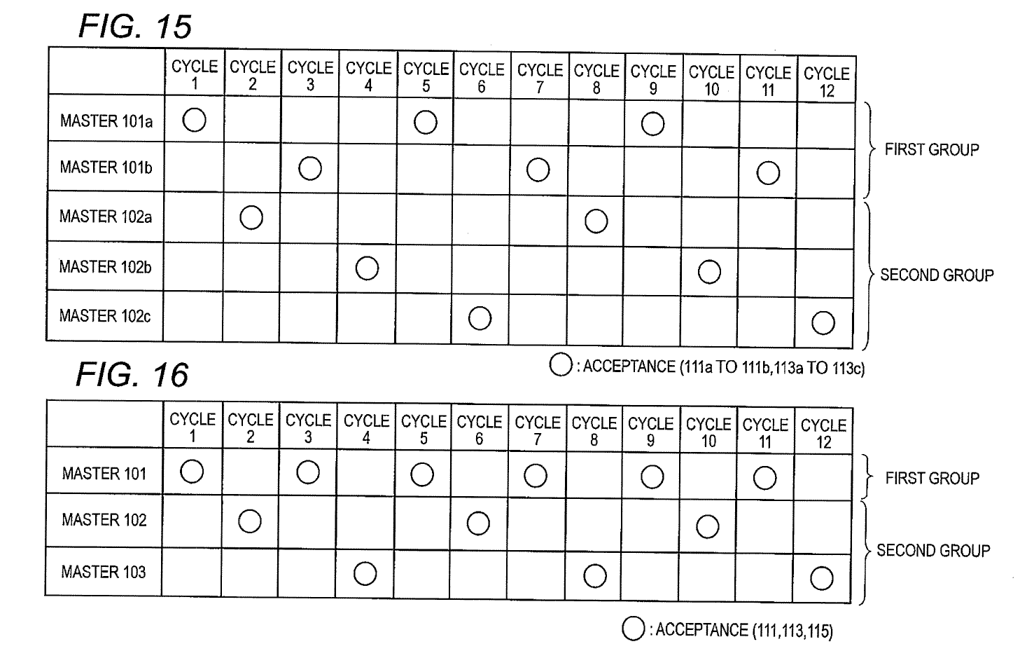

FIG. 15 is a diagram showing the arbitration results in cycles 1 to 12 when the arbitration results of FIGS. 13 and 14 are arbitrated with the round-robin arbitration 401. The round-robin arbitration 401 gives arbitration rights to the round-robin arbitration 403 of the first group once for every two cycles, and gives arbitration rights to the round-robin arbitration 402 of the second group once for every two cycles. Thus, the masters 101a and 101b can access the slave 118 once for every four cycles, and the masters 102a, 102b, and 102c can access the slave 118 once for every six cycles.

As described above, according to the bus arbitration apparatus of the fourth embodiment, the arbitration circuit 108 accepts the read/write requests from the masters 101a and 101b requiring low latency at a regular interval, for example, once for every four cycles, regardless of the presence of the masters 102a, 102b, and 102c, such as a DMA controller, having a memory access frequency. Thus, access of the masters 101a and 101b can be made with low latency, and the masters 102a, 102b, and 102c, such as a DMA controller, having a high memory access frequency are given access rights at least once for every six cycles. Therefore, it is possible to realize an arbitration method such that there is no where any slave access cannot be made due to low priority.

A small number of masters are arranged in the first group, and a large number of masters are arranged in the second group, thereby maintaining the latency of a master in the first group at high speed.

Although the invention has been described in detail in connection with a specific embodiment, it should be apparent to those skilled in the art that various changes or modifications may be made without departing from the spirit and scope of the invention.

The disclosure of Japanese Patent Application No. 2010-008928, filed on Jan. 19, 2010, including specification, drawings and claims is incorporated herein by reference in its entirety.

The invention is useful as a bus arbitration apparatus or the like which realizes a master (DMA controller or the like) requiring a wideband and a master (CPU or the like) requiring low latency in a bus in which a master, such as a CPU, and a master, such as a DMA controller, are mixed.

What is claimed is:

1. A bus arbitration apparatus which arbitrates a bus, comprising:
a plurality of masters;
at least one slave;
a bus to which the plurality of masters and the slave are connected and which is used for transmission from the plurality of masters to the slave;
an arbitration unit configured to receive a request from a specific master from among the plurality of masters with higher priority than a request from another master; and
a monitoring unit configured to monitor the requests from the plurality of masters transmitted to the slave through the bus,
wherein, as a result of monitoring by the monitoring unit, when the requests from the plurality of masters transmitted to the slave are retained, the arbitration unit performs control such that the request from another master decreases, and
the plurality of masters are divided into two or more groups including a first group to which the specific master belongs and a second group to which another master belongs.

2. The bus arbitration apparatus according to claim 1, wherein the arbitration unit selects masters in the first group at a regular interval, selects masters in the second group at a regular interval, and further selects the selected masters in the first group and the second group at a regular interval.

3. The bus arbitration apparatus according to claim 1, wherein the specific master is a master in which low latency is required, and another master is a master in which a wideband is required.
